(19) United States
(12) Patent Application Publication
(10) Pub. No.: US 2026/0221037 A1
(43) Pub. Date: Jul. 30, 2026

(54) Hazard alert system

(71) Applicant: Matthew Doran, Schererville, IN (US)

(72) Inventor: Matthew Doran, Schererville, IN (US)

(21) Appl. No.: 19/387,388

(22) Filed: Nov. 12, 2025

Related U.S. Application Data
(60) Provisional application No. 63/719,559, filed on Nov. 12, 2024.

(51) Int. Cl. G08G 1/16; G08G 1/0967; H04W 4/02; H04W 4/44; H04W 4/90

(52) U.S. Cl. CPC G08G 1/164; G08G 1/096725; G08G 1/166; H04W 4/025; H04W 4/44; H04W 4/90

(57) ABSTRACT

An alert system enables a person or object posing a potential hazard to proactively communicate its presence to nearby vehicles and computing systems. The system includes a computing device and an alert module integrated with or operatively coupled to the computing device. The alert module comprises an activating switch and a communicating portion configured to transmit hazard alert data, including the hazard's presence, location, and type, using any current or future wireless communication standard. The system may be implemented in hardware, software, or hybrid form and may be attachable, wearable, or vehicle integrated. By allowing hazards to announce their presence directly to driver-assist and autonomous vehicle systems, the invention provides early warnings that enhance situational awareness and reduce accident risk.

### CROSS-REFERENCE TO RELATED APPLICATIONS

The present application claims the benefits of U.S. Provisional Ser. No. 63/719,559 filed Nov. 12, 2024, the entirety of which is hereby incorporated by reference.

### BACKGROUND OF THE INVENTION

### Field of the Invention

The present invention relates to a computing device that, when used by a person that poses a hazard, is capable of providing alerts to object location processors. The object location processors being familiar today, electronic maps, to name one example. More particularly, the invention relates to systems and methods enabling individuals, vehicles, and other hazards to communicate their presence to object location processors, such as navigation systems or autonomous vehicle platforms, using direct wireless communication.

### Description of the Related Art

The inventor noted that vehicle accidents happen often because of distracted drivers or because of undetected objects on the road. In the inventor's experience, motorcycles involved in accidents are devastating and motorcycle activity could benefit from some sort of alert system to other drivers. When vehicles are being driven, drivers are tasked with noticing the hazards on the road. It is the failure to notice hazards that cause accidents. The accidents cause death and injury and involve, motorcyclists, cyclists, pedestrians, diabetics on the road, student drivers, slow moving cars, oversize loads, boats in tow, and a multitude of other human hazards.

Some road hazards can be, and often are, noted in computer software that alerts drivers. For example, a software program in an automobile could identify slow moving traffic.

Current driver-assist and autonomous driving systems may detect hazards through onboard sensors and remote data feeds. However, these systems generally operate in a reactive mode, detecting hazards only after they are within sensor range or reported indirectly by third party monitoring services. This latency can result in insufficient warning to avoid a collision.

There is a need for a proactive system by which hazards themselves can affirmatively identify and communicate their presence to surrounding vehicles and other road users, using direct, real-time communication. Such a system should support multiple embodiments, hardware, software, or hybrid-be attachable or portable, and be configurable to suit different hazard types, under age, elderly, handicapped, pets, to name a few examples, and environments.

There is a further need in the industry for an apparatus that allows users to alert drivers on the road of a hazard, usually themselves being the hazard. I noticed that a hazard, in my mind a human hazard, having the ability to identify itself as a hazard to the world via technology will alert drivers, at least, to the hazard. An apparatus and method for using it are not currently available in the industry.

### BRIEF SUMMARY OF THE INVENTION

The present invention provides a hazard alert system and method for proactively communicating the presence and location of a hazard to one or more object location processors. Object location processors are systems that process the location of things, there are electronic maps, GPS, satellite systems, virtual reality headsets, eyeglasses, phones, and cell towers, to name a few examples.

The system is designed to allow a person or object that may constitute a hazard, such as a pedestrian, cyclist, motorcyclist, operator of a slow-moving vehicle, operator of an oversized load, vehicle operator, or person on a stationary object, to directly transmit a real-time alert to nearby vehicles or autonomous systems.

In one embodiment, the system comprises a computing device operatively coupled to an alert module. The alert module includes an activating switch configured to selectively enable or disable a communicating portion, which transmits hazard alert data including location information of the hazard to one or more object location processors. The communicating portion may employ one or more communication technologies, including cellular, Wi-Fi, Bluetooth, satellite, mesh networking, or vehicle-to-everything (V2X) communications, or any future wireless standard capable of transmitting such data.

In certain embodiments, the system includes a location-determining component, such as a GPS receiver, to provide accurate location data associated with the hazard. The alert module may also be configured to transmit the hazard alert data automatically when the hazard is within a predefined proximity of an approaching vehicle, thereby providing an early warning signal. The computing device may comprise a mobile, wearable, or vehicle-integrated computing platform.

Additional embodiments include a hazard type selector allowing the user to specify one or more descriptive characteristics of the hazard, such as “student driver,” “novice motorcyclist,” or “slow-moving vehicle.” The alert module may be removably attachable to a person, vehicle, or object associated with the hazard, including but not limited to a handlebar, helmet, or dashboard mount. The module may further comprise a software application stored on the computing device and may generate visual or audible confirmation to the user when activated.

The communicating portion may automatically select among available communication networks to optimize range and reliability under varying environmental or traffic conditions. The transmitted hazard alert data may be received by one or more autonomous vehicle control systems or object location processors configured to adjust vehicle operation or issue a driver alert in response.

In operation, the invention also provides a method of generating and transmitting hazard alerts. The method includes identifying a hazard associated with a user, activating an alert module coupled to a computing device, and transmitting hazard alert data including the hazard's location to one or more object location processors. The method may further include providing descriptive data identifying the hazard type, selecting communication standards or network modes for transmission, and ensuring the alert data is processed within autonomous vehicle control systems to generate a driver alert or automatic control response.

Through these configurations, the invention incorporates the flexibility and functionality described in the various dependent claims, encompassing different communication modes, activation schemes, computing device types, attachment mechanisms, and feedback features. By allowing hazards to affirmatively announce their presence rather than relying solely on third-party or sensor-based detection, the system and method deliver a proactive, adaptable, and scalable solution for road safety. The invention enables earlier hazard recognition, reduces driver reaction time, and enhances safety for all road users through direct, real-time communication between potential hazards and vehicle control systems.

The inventor envisioned a device or software on a device being activated and communicating with systems used by drivers and alerting those drivers of the hazard to name one example. The inventor considers this like a user raising their hand to a driver assist system rather than “tattle-tales” advising the system. So, the invention enables the hazard to initiate communication directly rather than relying on indirect third-party detection.

Again, the present invention provides a system and method enabling a hazard, such as a motorcyclist, pedestrian, cyclist, slow-moving vehicle, or other object, to transmit its presence and, optionally, its type and other relevant information to nearby vehicles and computing devices.

In one embodiment, the invention comprises an alert module integrated with or attached to the hazard, having a communicating portion for transmitting an alert signal to one or more nearby vehicles, infrastructure systems, or mobile devices. The communicating portion may utilize any current or future wireless protocol, including but not limited to cellular, Wi-Fi, Bluetooth, vehicle-to-everything (V2X), satellite, mesh networking, or proprietary protocols.

By way of example, the invention could comprise a software application operating on an existing computing device, such as a smartphone, wearable, or vehicle-integrated computer, configured to transmit hazard alerts when activated.

The system may include a GPS or other location-determining components to provide precise hazard location. A user interface for activating or deactivating alerts. Optional configuration to adjust the range or timing of alerts. Or a transmission of hazard characteristics, such as “novice driver,” “oversized load,” or “disabled vehicle.”

By enabling hazards to communicate directly and proactively with vehicle systems, the invention allows drivers and autonomous systems to receive earlier warnings, increasing reaction time and reducing accident risk.

### BRIEF DESCRIPTION OF THE SEVERAL VIEWS OF THE DRAWINGS

These and other features, aspects and advantages of the present invention will become better understood with regard to the following description, appended claims, and accompanying drawings where:

FIG. 1 is a perspective view of an embodiment of the invention comprising an alert module integrated with a computing device, capable of communicating with a remote network.

FIG. 2 is a perspective view of another embodiment of the invention comprising an alert module attached to a handlebar of a motorcycle.

FIG. 3 is a perspective view of another embodiment of the invention comprising a wearable cased device attached to a handlebar, illustrating integration of a hazard type selector and activation switch.

### DETAILED DESCRIPTION OF THE INVENTION

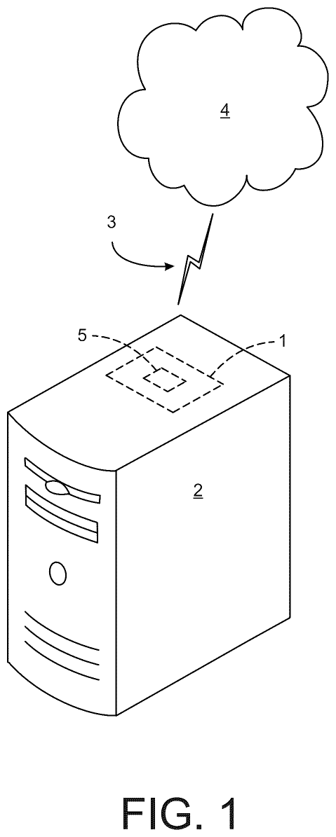

As shown in FIG. 1, a perspective drawing of an embodiment of the invention comprises a novel hazard alert module 1 integrated, or operationally coupled, with a computing device 2. A communicating portion 5 integrated on the hazard alert module 1 is communicating hazard alert data 3 with an object location processor 4.

The communicating portion 5 may comprise any wired or wireless interface suitable for data exchange, including but not limited to cellular, Wi-Fi, Bluetooth, satellite, mesh, or vehicle-to-everything (V2X) communication protocols, as well as future-developed equivalents. The object location processor 4 may be embodied in a vehicle's driver-assist or autonomous navigation system, a roadside or networked infrastructure system, or a mobile computing platform configured to process positional information of surrounding objects.

In certain embodiments, the hazard alert module 1 includes an internal processor, memory, and one or more sensors or positioning subsystems such as GPS for determining its location. The computing device 2 may host software that formats the outgoing hazard alert data and manages user input, including activation, deactivation, or configuration of the alert range and parameters. When the hazard alert module 1 is activated, the communicating portion 5 transmits an alert signal containing hazard identification and, optionally, location or characteristic data to the object location processor 4, which interprets the signal and generates a warning or display to a vehicle operator or automated control system.

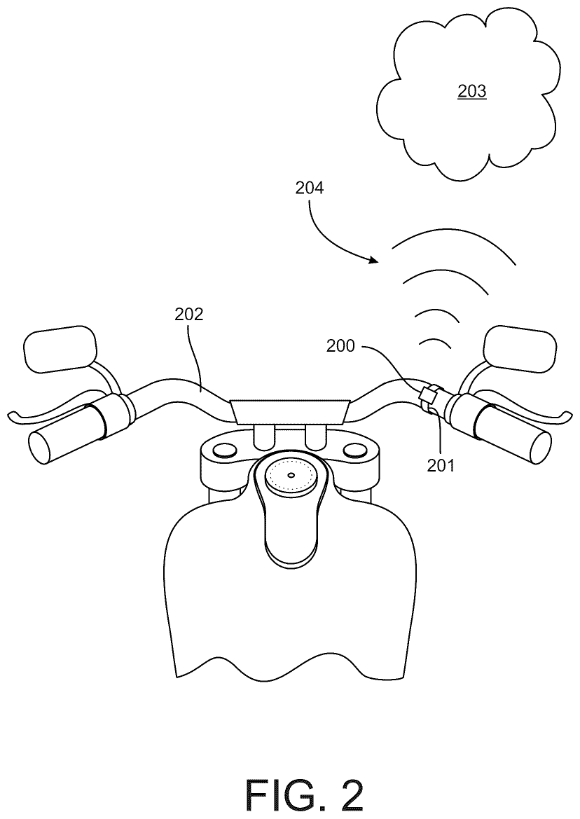

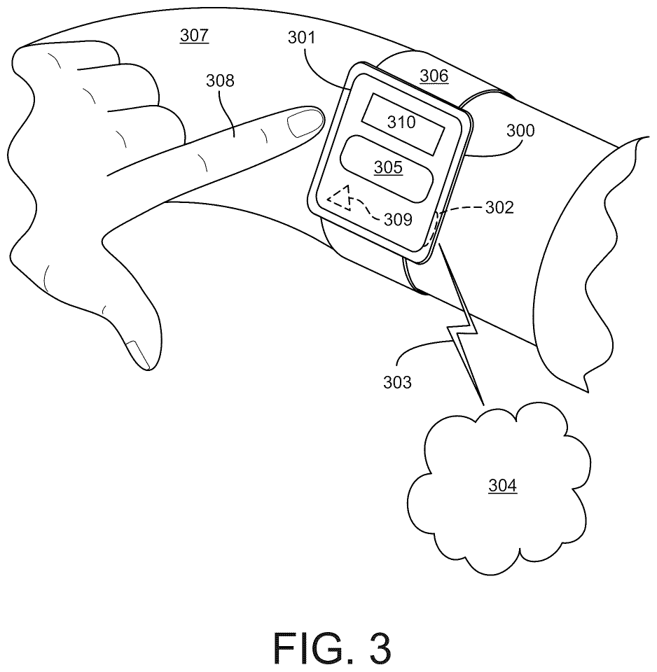

As shown in FIG. 2, a perspective drawing of another embodiment of the invention comprises a hazard alert module 200 being attached via a band, which could be any type of attachment, 201 to a handlebar of a motorcycle 202. The hazard alert module 200 having integrated a communicating portion (FIGS. 3, 302) alarm capable of communicating 204 with an object location processor 203. The attachment 201 may be accomplished by any suitable means, including mechanical clamps, brackets, adhesive fasteners, magnets, or integrated housings formed as part of the vehicle's frame or handlebar.

In this embodiment, the hazard alert module 200 is positioned for optimal signal transmission and user accessibility. The module may include a power supply such as a rechargeable battery, a wired connection to the vehicle's electrical system, or an energy-harvesting subsystem (for example, solar or kinetic). The module 200 may also include a user-actuated switch or control that enables a rider or operator to selectively activate or deactivate the alert transmission.

The communicating portion (FIGS. 3, 302) can utilize any current or future wireless standard for communication with nearby vehicles or infrastructure systems, including but not limited to cellular, Wi-Fi, Bluetooth, satellite, mesh networking, or vehicle-to-everything (V2X) protocols. The transmitted data 204 may include hazard alert information such as the current position of the motorcycle, its movement direction, velocity, or hazard classification (e.g., “motorcycle present,” “slow vehicle ahead,” or “novice rider”).

In operation, the object location processor 203, which may reside within a nearby vehicle, roadside unit, or cloud-based traffic coordination system, receives and processes the transmitted data from the communicating portion 204. The processor 203 may then generate an alert or visual indicator to notify nearby drivers or autonomous systems of the hazard's presence and nature, thereby improving awareness in a situation and reducing collision risk.

The embodiments illustrated in FIGS. 1 and 2 represent complementary implementations of the same inventive concept—namely, a system enabling a hazard to actively transmit its presence to other road users and automated systems. The embodiment of FIG. 1 illustrates a generalized or integrated form of the hazard alert module suitable for installation within or coupling to various computing devices, while the embodiment of FIG. 2 demonstrates a specific mounted configuration for a vehicle, such as a motorcycle. In both embodiments, the hazard alert module performs substantially similar functions: activation by or on behalf of a hazard, transmission of alert data through one or more communication protocols, and reception of that data by an object location processor or equivalent system that interprets the information for display or automated response. These embodiments are illustrative rather than limiting, and variations in attachment method, form factor, communication technology, or integration level may be implemented without departing from the scope of the invention.

As shown in FIG. 3, a perspective drawing of another embodiment of the invention comprises a hazard alert module 301 in this case it is part of a wearable cased device 300. The hazard alert module 301 is attached to a handlebar 307 via a band 306. There is integrated into the hazard alert module 301 a communicating portion 302.

In this embodiment, the hazard alert module 301 comprises an integrated location determining component 309, such as a GPS receiver or equivalent location-determining subsystem for example. A user 308 can operate an activating switch 305 to cause the communicating portion 302 to begin transmitting a hazard alert data 303, dad\ta is used generally to describe one or more bits of digital information, for receipt and processing in the cloud, where the infrastructure for an object location processor 304 is reachable. A hazard type selector 310 can also be operated by the person, the hazard, to provide more information to be included in the hazard alert data 302. The way a person enters the information is via readily available software input screens. Both the activating switch and the hazard type indicator can be operated by physical control or software menu (as shown here)

Customary but not shown are a power supply, which may be battery-based, solar assisted, or vehicle-powered; A processor executing instructions to format and transmit hazard alerts; A user interface for activation/deactivation; Optional encryption or authentication for secure communication.

In software-only embodiments, the alert system operates as an application on a smartphone, wearable device, or vehicle infotainment system. Activation may occur manually via user input or automatically upon detection of certain conditions, such as reduced vehicle speed, roadside location, or user selection of a hazard mode.

In hybrid embodiments, the alert system includes a dedicated hardware unit operating in conjunction with an application installed on the user's mobile device. The hardware unit may provide additional capabilities such as extended-range transmission or integration with external sensors.

The system is intended to be configurable such that hazard alerts may be transmitted well in advance, for example, one thousand feet before a vehicle approaches, and may be tailored to environmental factors such as road type, weather conditions, or traffic density.

The inventor found that this device and method of allowing a human hazard to affirmatively activate an alert that is recognized by one or more driver assisting computer programs in an object location processor is a functional device for avoiding accidents with hazards on the road.

The best mode of my improved method involves providing an improved alert, comprising identifying existence of a personal hazard. Then attaching the improved alert to the personal hazard and activating the improved alert. The improved alert communicating with one or more computer systems used by drivers.

Although the present invention has been described in considerable detail with the reference to certain preferred versions thereof, other versions are possible. For instance, the apparatus may be useful for people on motorcycles, it is useful for any person posing a hazard on a public thoroughfare. Therefore, the spirit and scope of the appended claims should not be limited to the description of the preferred versions contained herein. It will be understood that the invention encompasses any combination of hardware, software, or firmware components configured to perform the described functions.

Any element in a claim that does not explicitly state “means for” performing a specified function, or “step for” performing a specific function, is not to be interpreted as a “means” or “step” clause as specified in 35 U.S.C. § 112, ¶ 6. In particular, the use of “step of” in the claims herein is not intended to invoke the provisions of 35 U.S.C. § 112, ¶ 6.

1. A hazard alert system for communicating the presence of a hazard to one or more object location processors, the hazard alert system comprising:
a computing device;
an alert module operatively coupled to the computing device;
a communicating portion operatively coupled to the alert module;
an activating switch configured to selectively enable or disable the communicating portion;
wherein the activating switch is operable by a hazard, the hazard comprising a pedestrian, cyclist, motorcyclist, operator of a slow-moving vehicle, operator of an oversized load, a vehicle operator, or a person on a stationary object; and
wherein the communicating portion transmits hazard alert data including location information of the hazard to at least one of the object location processors.

2. The hazard alert system of claim 1 wherein the communicating portion transmits the hazard alert data via at least one of cellular, Wi-Fi, Bluetooth, satellite, mesh networking, or vehicle-to-everything (V2X) communication technologies.

3. The hazard alert system of claim 1 further comprising a location-determining component configured to provide location data with the hazard alert data.

4. The hazard alert system of claim 1 wherein the alert module is configured to transmit the hazard alert data when the hazard is within a predefined proximity of an approaching vehicle to provide an early warning signal.

5. The hazard alert system of claim 1, wherein the computing device comprises a mobile, wearable, or vehicle-integrated computing platform.

6. The hazard alert system of claim 1 further comprising a hazard type selector configured to allow the hazard to specify one or more characteristics of the hazard.

7. The hazard alert system of claim 1 wherein the alert module is removably attachable to a vehicle, a person, or an object associated with the hazard.

8. The hazard alert system of claim 1 wherein the communicating portion transmits hazard alert data to one or more autonomous vehicle control systems configured to modify vehicle operation in response to the received data.

9. The hazard alert system of claim 1 wherein the alert module is configured for attachment to one or more of handlebar, helmet, or dashboard mount.

10. The hazard alert system of claim 1 wherein the alert module comprises a software application stored in the computing device.

11. The hazard alert system of claim 1 wherein activation of the alert module triggers a visual or audible confirmation to the hazard.

12. The hazard alert system of claim 1 wherein the communicating portion automatically selects between available networks to optimize communication range.

13. A method of providing hazard alerts, comprising:
identifying a hazard associated with a user;
activating an alert module operatively coupled to a computing device;
transmitting hazard alert data including the hazard's location to one or more object location processors via a communicating portion configured to use one or more wireless communication standards.

14. The method of claim 13 further comprising providing descriptive data identifying a type or characteristic of the hazard along with the hazard alert data.

15. The method of claim 13 wherein the hazard is selected from the group of: pedestrian, cyclist, motorcyclist, operator of a slow-moving vehicle, operator of an oversized load, a vehicle's operator, or a person on a stationary object.

16. The method of claim 13 wherein the communicating portion transmits the hazard alert data via at least one of cellular, Wi-Fi, Bluetooth, satellite, mesh networking, or vehicle-to-everything (V2X) communication technologies.

17. The method of claim 13 further comprising allowing the user to select a hazard type prior to transmitting the hazard alert data.

18. The method of claim 13 wherein the hazard alert data is received by and processed within autonomous vehicle control systems to generate a driver alert or automatic control response providing early warning.

19. The hazard alert system of claim 1 wherein the system is configured for communicating the presence and location of a hazard to one or more autonomous vehicle control systems, the system comprising:
a computing device comprising a mobile, wearable, or vehicle-integrated computing platform;
an alert module removably attachable to a handlebar, helmet, or dashboard mount, the alert module operatively coupled to the computing device;
a communicating portion operatively coupled to the alert module and configured to automatically select between available networks among cellular, Wi-Fi, Bluetooth, satellite, mesh networking, and vehicle-to-everything (V2X) communication technologies to optimize communication range;
a location-determining component configured to provide location data with hazard alert data;
an activating switch configured to selectively enable or disable the communicating portion, the activating switch being operable by a pedestrian, cyclist, or motorcyclist constituting the hazard; and
wherein activation of the activating switch causes the alert module to transmit the hazard alert data including the location data to at least one of the autonomous vehicle control systems to provide an early warning signal when the hazard is within a predefined proximity of an approaching vehicle, and to generate a visual or audible confirmation to the hazard.

20. The hazard alert system of claim 19, further comprising a hazard type selector configured to allow the hazard to specify one or more characteristics of the hazard, wherein the alert module comprises a software application stored in the computing device and executable to perform transmission of the hazard alert data according to the specified hazard characteristics.
